(19) United States
(12) Patent Application Publication
(10) Pub. No.: US 2025/0317657 A1
(43) Pub. Date: Oct. 9, 2025

(54) IMAGING METHOD AND IMAGING APPARATUS

(71) Applicant: ARASHI VISION INC., Shenzhen (CN)

(72) Inventors: Haiyong LI, Shenzhen (CN); Kun TAN, Shenzhen (CN); Wenhui ZHENG, Shenzhen (CN); Jingkang LIU, Shenzhen (CN)

(73) Assignee: ARASHI VISION INC., Shenzhen (CN)

(21) Appl. No.: 19/173,966

(22) Filed: Apr. 9, 2025

(30) Foreign Application Priority Data
Apr. 9, 2024 (CN) 202410418591.8

(51) Int. Cl. H04N 23/743; H04N 23/55; H04N 23/61; H04N 23/63; H04N 25/47

(52) U.S. Cl. CPC H04N 23/743; H04N 23/55; H04N 23/61; H04N 23/635; H04N 25/47

(57) ABSTRACT

The present disclosure provides some implementations of an imaging method that is applied to an imaging apparatus. The imaging method may include, in response to a first imaging trigger operation, capturing a first image based on first orientation information. A brightness difference between a first region of the first image and a second region of a second image is less than a preset brightness difference. The imaging poses of the first image and the second image can be different, and an overlapping view-finding region includes the first region and the second region.

### CROSS-REFERENCE TO RELATED APPLICATION

This application claims the benefit of priority to Chinese Patent Application No. 202410418591.8, filed on Apr. 9, 2024, the entire content of which is hereby incorporated by reference in its entirety.

### BACKGROUND

The present disclosure relates to the field of electronic devices, particularly to an imaging method and an imaging apparatus.

In recent years, with the iteration of imaging apparatuses and the development of image processing technology, various types and functions of imaging apparatuses have been widely applied in fields such as industry, intelligent human-computer interaction, and autonomous driving, as well as in people's daily lives. When using an imaging apparatus for capturing images, it is usually necessary to change the pose of the imaging apparatus to capture images corresponding to different view-finding regions.

However, when using imaging methods of related technologies, the brightness of images captured changes with the change in the imaging pose of the imaging apparatus in the same imaging scene, leading to inconsistent brightness in overlapping parts of the view-finding regions in different images, resulting in insufficient exposure stability and consistency, and poor user experience.

### SUMMARY

To overcome the problems in related technologies, the present disclosure provides an imaging device.

To overcome the problems in related technologies, the present disclosure provides an imaging method and an imaging apparatus.

According to a first aspect of the implementations of the present disclosure, an imaging method is provided, applied to an imaging apparatus. The imaging method includes the following.

In response to a first imaging trigger operation, capturing a first image based on first orientation information, so that a brightness difference between a first region of the first image and a second region of a second image is less than a preset brightness difference, where the imaging poses of the first image and the second image are different, and the overlapping view-finding region includes the first region and the second region.

In some implementations of the present disclosure, the first orientation information includes any one or any combination of first camera pose information, first horizon information, first gravity direction information, or first forward direction information.

In some implementations of the present disclosure, the method of obtaining the first horizon information includes:
obtaining the first horizon information through artificial intelligence recognition; or
determining the first horizon information based on first camera pose information; or
determining the first horizon information based on gyroscope data of the imaging apparatus.

In some implementations of the present disclosure, the imaging pose of the first image and the imaging pose of the second image are different poses of the imaging apparatus in the same imaging scene.

In some implementations of the present disclosure, under the imaging pose of the first image and the imaging pose of the second image, the direction of the lens of the imaging apparatus is different.

In some implementations of the present disclosure, under the imaging pose of the first image and the imaging pose of the second image, the optical axes of the lens of the imaging apparatus are substantially parallel or form an included angle.

In some implementations of the present disclosure, if the optical axis of the lens of the imaging apparatus forms an included angle under the imaging pose of the first image and the imaging pose of the second image, the optical axis of the lens is inclined in different directions relative to the horizontal plane.

In some implementations of the present disclosure, under the imaging pose of the first image, the optical axis of the lens of the imaging apparatus forms an included angle with the gravity direction; and/or
under the imaging pose of the second image, the optical axis of the lens of the imaging apparatus is substantially perpendicular to the gravity direction.

In some implementations of the present disclosure, the view-finding region of the second image corresponds to a default light metering table.

Capturing the first image based on the first orientation information includes:
determining a first pose change amount from the imaging pose of the second image to the imaging pose of the first image based on the first orientation information;
moving or transforming the default light metering table based on the first pose change amount to obtain an updated light metering table; and
capturing the first image based on the updated light metering table.

In some implementations of the present disclosure, before capturing the first image based on the first orientation information in response to the first imaging trigger operation, the imaging method further includes:
capturing the second image based on the second orientation information in response to a second imaging trigger operation.

In some implementations of the present disclosure, capturing the second image based on the second orientation information in response to the second imaging trigger operation includes:
adjusting current exposure parameters of the imaging apparatus based on the second orientation information to obtain the second image; and
capturing the first image based on the first orientation information in response to the first imaging trigger operation includes:
adjusting current exposure parameters of the imaging apparatus based on the first orientation information to obtain the first image,
where the brightness of the first region and the brightness of the second region both correspond to the brightness of a current imaging scene.

In some implementations of the present disclosure, the second orientation information includes any one or any combination of second camera pose information, second horizon information, second gravity direction information, or second forward direction information.

In some implementations of the present disclosure, the method of obtaining the second horizon information includes:
obtaining the second horizon information through artificial intelligence recognition; or
determining the second horizon information based on second camera pose information; or
determining the second horizon information based on gyroscope data of the imaging apparatus.

In some implementations of the present disclosure, capturing the second image based on the second orientation information in response to the second imaging trigger operation includes:
determining first correction light metering information based on the second orientation information and preset light metering information;
performing image exposure based on the first correction light metering information to obtain the second image; and
capturing the first image based on the first orientation information in response to the first imaging trigger operation includes:
determining second correction light metering information based on the first orientation information and preset light metering information; and
performing image exposure based on the second correction light metering information to obtain the first image.

In some implementations of the present disclosure, the preset light metering information includes a preset light metering table, which is configured to characterize preset light metering weights corresponding to a plurality of light metering sub-regions into which a light metering region of the imaging apparatus is divided.

The first correction light metering information includes a first light metering table, which is configured to characterize first light metering weights corresponding to the plurality of light metering sub-regions.

The second correction light metering information includes a second light metering table, which is configured to characterize second light metering weights corresponding to the plurality of light metering sub-regions.

In some implementations of the present disclosure, the preset light metering weight corresponding to a light metering sub-region at the center of the light metering region is greater than the preset light metering weight of a light metering sub-region at the edge of the light metering region.

In some implementations of the present disclosure, determining first correction light metering information based on the second orientation information and preset light metering information includes:
determining first transformation information based on the second orientation information and the preset pose information corresponding to the preset light metering information, where the first transformation information is used to characterize the degree and/or mode of pose change from the preset pose to the imaging pose of the second image;
determining the first correction light metering information based on the preset light metering information and the first transformation information;
determining second correction light metering information based on the first orientation information and preset light metering information includes:
determining second transformation information based on the first orientation information and the preset pose information corresponding to the preset light metering information, where the second transformation information is used to characterize the degree and/or mode of pose change from the preset pose to the imaging pose of the first image; and
determining the second correction light metering information based on the preset light metering information and the second transformation information.

In some implementations of the present disclosure, under the preset pose, the optical axis of the lens of the imaging apparatus is in a horizontal direction.

In some implementations of the present disclosure, determining the first correction light metering information based on the preset light metering information and the first transformation information includes:
determining the first correction light metering information based on the first transformation information and preset configuration information corresponding to the preset light metering information. The preset configuration information is used to characterize the correspondence between the degree and/or mode of pose change and the light metering information after the pose change; and
determining the second correction light metering information based on the preset light metering information and the second transformation information includes:
determining the second correction light metering information based on the second transformation information and preset configuration information corresponding to the preset light metering information.

In some implementations of the present disclosure, the first transformation information includes a pose change amount of the imaging apparatus along a first preset direction. Determining the first correction light metering information based on the preset light metering information and the first transformation information includes:
if the pose change amount of the imaging apparatus along the first preset direction is in a first preset range, translating and replacing the preset light metering weights of the plurality of light metering sub-regions along a reverse direction of the first preset direction to obtain the first correction light metering information; and
the second transformation information includes a pose change amount of the imaging apparatus along a second preset direction, and determining the second correction light metering information based on the preset light metering information and the second transformation information includes:
if the pose change amount of the imaging apparatus along the second preset direction is in a second preset range, translating and replacing the preset light metering weights of the plurality of light metering sub-regions along a reverse direction of the second preset direction to obtain the second correction light metering information.

In some implementations of the present disclosure, performing image exposure based on the first correction light metering information to obtain the second image includes:
determining a first brightness value corresponding to the view-finding region of the second image based on the first correction light metering information and first brightness information, where the first brightness information is used to characterize brightness data corresponding to a plurality of light metering sub-regions into which a light metering region of the second image is divided under the imaging pose of the second image;
determining a first exposure parameter set based on the first brightness value. The first exposure parameter set includes a plurality of first exposure parameters configured for image exposure;
performing image exposure on the view-finding region of the second image based on the first exposure parameter set to obtain the second image; and
performing image exposure based on the second correction light metering information to obtain the first image includes:
determining a second brightness value corresponding to the view-finding region of the first image based on the second correction light metering information and second brightness information, where the second brightness information is used to characterize brightness data corresponding to a plurality of light metering sub-regions into which a light metering region of the first image is divided under the imaging pose of the first image;
determining a second exposure parameter set based on the second brightness value, where he second exposure parameter set includes a plurality of second exposure parameters configured for image exposure; and
performing image exposure on the view-finding region of the first image based on the second exposure parameter set to obtain the first image.

In some implementations of the present disclosure, the imaging method further includes:
determining the preset light metering information based on a preset custom operation of a user; or
determining one of a plurality of pieces of initial light metering information as the preset light metering information based on a preset selection operation of a user.

According to a second aspect of the implementations of the present disclosure, an imaging apparatus is provided. The imaging apparatus includes:
a lens assembly;
an imaging module, configured to capture a first image based on first orientation information in response to a first imaging trigger operation, so that a brightness difference between a first region of the first image and a second region of a second image is less than a preset brightness difference,
where the imaging poses of the first image and the second image are different, and the overlapping view-finding region includes the first region and the second region.

The technical solutions provided by the implementations of the present disclosure can include the following beneficial effects: when the imaging apparatus recognizes the first imaging trigger operation, capturing the first image based on the first orientation information ensures that the brightness of the first region of the first image and the second region of the second image is substantially the same even when the imaging poses of the first and second images are different, ensuring exposure stability and consistency of the overlapping view-finding region in different images, enhancing user experience.

It should be understood that the above general description and the detailed description below are merely exemplary and explanatory and do not limit the present disclosure.

### BRIEF DESCRIPTION OF DRAWINGS

The accompanying drawings, which are incorporated in and constitute a part of this specification, illustrate implementations of the present disclosure and, together with the description, serve to explain the principles of the present disclosure.

FIG. 1 is a flowchart of an imaging method according to an implementation of the present disclosure.

FIG. 2 is a schematic diagram of the imaging pose of the first image and the imaging pose of the second image according to an implementation of the present disclosure.

FIG. 3 is a schematic diagram of the imaging apparatus under the imaging pose of the first image according to an implementation of the present disclosure.

FIG. 4 is a schematic diagram of the imaging apparatus under the imaging pose of the second image according to an implementation of the present disclosure.

FIG. 5 is a flowchart of capturing the first image based on first orientation information according to an implementation of the present disclosure.

FIG. 6 is a flowchart of capturing the second image based on second orientation information in response to a second imaging trigger operation according to an implementation of the present disclosure.

FIG. 7 is a schematic diagram of the view-finding region of the second image according to an implementation of the present disclosure.

FIG. 8 is a flowchart of capturing the first image based on first orientation information in response to a first imaging trigger operation according to an implementation of the present disclosure.

FIG. 9 is a schematic diagram of the view-finding region of the first image according to an implementation of the present disclosure.

FIG. 10 is a schematic diagram of a preset light metering table according to an implementation of the present disclosure.

FIG. 11 is a schematic diagram of a first light metering table according to an implementation of the present disclosure.

FIG. 12 is a schematic diagram of a second light metering table according to an implementation of the present disclosure.

FIG. 13 is a flowchart of determining first correction light metering information based on second orientation information and preset light metering information according to an implementation of the present disclosure.

FIG. 14 is a flowchart of determining second correction light metering information based on first orientation information and preset light metering information according to an implementation of the present disclosure.

FIG. 15 is a flowchart of performing image exposure based on first correction light metering information to obtain the second image according to an implementation of the present disclosure.

FIG. 16 is a flowchart of performing image exposure based on second correction light metering information to obtain the first image according to an implementation of the present disclosure.

FIG. 17 is a flowchart of an imaging method according to another implementation of the present disclosure.

FIG. 18 is a block diagram of an imaging apparatus according to an implementation of the present disclosure.

Some implementations of the present disclosure will be described with reference to the accompanying drawings.

### DETAILED DESCRIPTION

The exemplary implementations will be described in detail here, with examples illustrated in the accompanying drawings. In the following description, when referring to the drawings, unless otherwise stated, the same numbers in different drawings represent the same or similar elements. The implementations described in the following exemplary implementations do not represent all implementations consistent with the present disclosure. Instead, they are merely examples of devices and methods consistent with some aspects of the present disclosure as detailed in the appended claims.

In recent years, with the rapid iteration of imaging apparatus and continuous development of image processing technology, various types and functions of imaging apparatus such as cameras and mobile phones have been widely applied in fields like industry, intelligent human-computer interaction, and autonomous driving, and can capture beautiful moments anytime and anywhere in daily life. When using an imaging apparatus for capturing images, it is usually necessary to change the imaging pose of the apparatus to capture images corresponding to different view-finding regions.

In related technologies, when the imaging pose of the imaging apparatus changes, the optical center of its imaging module changes accordingly, which will cause the metering data and exposure parameters of the imaging apparatus in the same scene to change.

However, when using imaging methods of related technologies for capturing images, even if the images captured in different imaging poses have partially overlapping view-finding regions, the brightness of this overlapping view-finding region in different images will still be inconsistent, leading to insufficient exposure stability and consistency, which is not conducive to subsequent processing such as panoramic image synthesis and target tracking with multiple images captured in different imaging poses, resulting in poor user experience.

Based on this, the implementations of the present disclosure provide an imaging method, which, when the imaging apparatus recognizes a first imaging trigger operation, captures a first image based on first orientation information, ensuring that a first region of the first image and a second region of a second image have substantially the same brightness when captured in different imaging poses, thereby ensuring exposure stability and consistency of the overlapping view-finding region in different images, enhancing user experience.

The imaging method provided in the implementations of the present disclosure can be applied to application scenarios of imaging apparatus such as cameras and mobile phones, and can obtain the recognition of a first imaging trigger operation of the imaging apparatus and capture the first image based on the acquired first orientation information. In some implementations, the camera can be a panoramic camera.

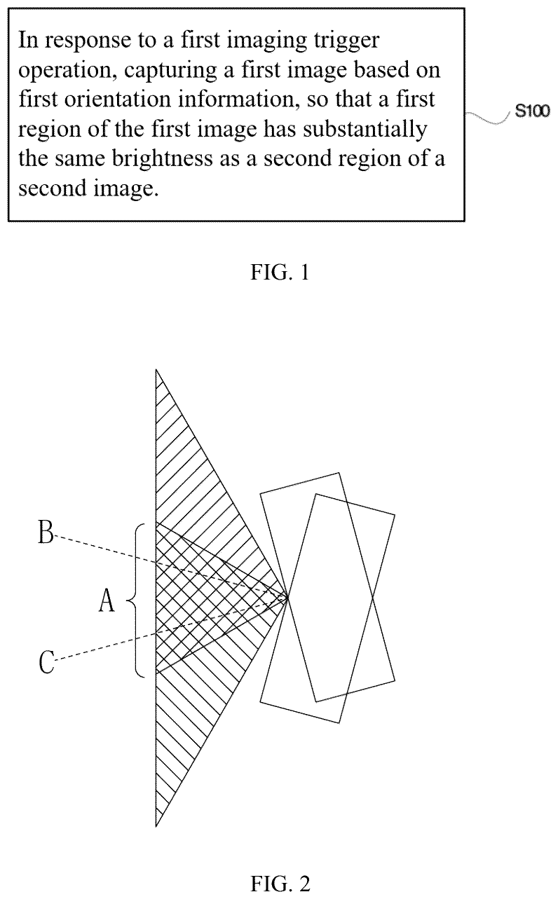

In an implementation, an imaging method is provided, applied to an imaging apparatus, which may include devices like cameras and mobile phones with a lens assembly and an imaging module for capturing images. Referring to FIG. 1, the imaging method includes the following operations.
S100: In response to a first imaging trigger operation, capturing a first image based on first orientation information, so that a first region of the first image has substantially the same brightness as a second region of a second image.

In S100, the imaging pose of the first image and the imaging pose of the second image are different, and the overlapping view-finding region includes the first region and the second region.

The first imaging trigger operation is an operation made by the user to control the imaging apparatus to capture an image. In some implementations, the first imaging trigger operation can be an operation such as the user pressing the capture button or clicking the capture control in the interactive interface.

When the imaging apparatus recognizes the first imaging trigger operation, it captures the first image based on the first orientation information, which is used to characterize the current pose of the imaging apparatus during the capturing of the first image based on reference information. The first orientation information can be relevant information of the imaging pose of the imaging apparatus in actual physical coordinate space, and the reference information at this time can be relevant information of the calibrated pose of the imaging apparatus in actual physical space. The first orientation information can also be relevant information of the relative pose of the imaging apparatus with a preset reference object, and the reference information at this time can be relevant information of the preset reference object. The first orientation information changes synchronously when the imaging apparatus is in different imaging poses.

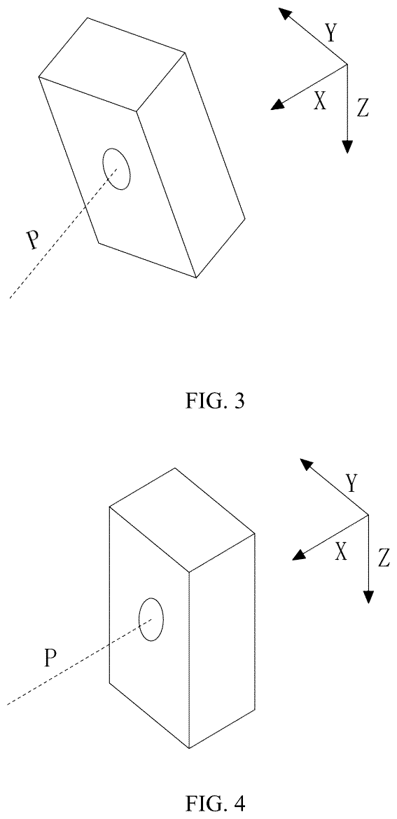

It can be understood that the second image has already been captured before capturing the first image. For example, the second image can be captured based on second orientation information before capturing the first image. Referring to FIG. 2, the imaging pose of the imaging apparatus for capturing the first image is different from the imaging pose for capturing the second image. The view-finding regions of the imaging apparatus in the two imaging poses partially overlap, and the overlapping view-finding region A includes the first region and the second region in the first image and the second image, respectively. Capturing the first image based on the first orientation information ensures that the brightness of the first region of the first image and the second region of the second image is substantially the same, thereby ensuring that the brightness of the overlapping view-finding region in the first image and the second image is substantially the same. Substantially the same brightness can mean that the brightness difference between the first region and the second region is less than a preset brightness difference.

In this implementation, when the imaging apparatus recognizes the first imaging trigger operation, capturing the first image based on the first orientation information ensures that the first region of the first image and the second region of the second image have substantially the same brightness when the imaging poses of the first image and the second image are different, ensuring exposure stability and consistency of the overlapping view-finding region in different images, which is conducive to subsequent processing such as panoramic image synthesis and target tracking with multiple images captured in different imaging poses, enhancing user experience.

In some implementations, the first orientation information includes any one or any combination of a plurality of types of first camera pose information, first horizon information, first gravity direction information, or first forward direction information.

As mentioned earlier, the first orientation information can characterize the current pose of the imaging apparatus during the capturing of the first image. The first orientation information can be first camera pose information, which can characterize the imaging pose of the imaging apparatus in actual physical space coordinates. For example, the first camera pose information can be determined by obtaining gyroscope data of the imaging apparatus and based on a preset calibrated pose, i.e., the calibrated pose of the gyroscope.

The first orientation information can also be first horizon information, which can characterize the position of the horizon in the view-finding region under the imaging pose of the first image, allowing the horizon to be used as a reference to characterize the relative pose of the imaging apparatus with the horizon through the first horizon information, so that the first horizon information can characterize the current pose of the imaging apparatus as first orientation information.

The first orientation information can also be first gravity direction information or first forward direction information. The first gravity direction information can characterize the spatial rotation variation of the imaging apparatus relative to the gravity direction under the imaging pose of the first image. The first forward direction information can characterize the spatial rotation variation of the imaging apparatus relative to the forward direction, i.e., the horizontal direction, under the imaging pose of the first image. The gravity direction or forward direction can be used as a reference direction to characterize the relative pose of the imaging apparatus with the gravity direction or forward direction through the first gravity direction information or first forward direction information, so that the first gravity direction information or first forward direction information can characterize the current pose of the imaging apparatus as first orientation information.

In this implementation, any one or any combination of first camera pose information, first horizon information, first gravity direction information, or first forward direction information is used as first orientation information, allowing the imaging pose of capturing the first image to be characterized by the imaging pose of the imaging apparatus in actual physical space coordinates and the relative pose information with a preset reference object or preset reference direction, providing a basis for capturing the first image, ensuring exposure stability and consistency of the overlapping view-finding region in different images, enhancing user experience.

In some implementations, the acquisition method of the first horizon information includes: obtaining the first horizon information through artificial intelligence recognition; or determining the first horizon information based on the first camera pose information; or determining the first horizon information based on gyroscope data of the imaging apparatus.

The first horizon information can be obtained through Artificial Intelligence (AI) recognition. In some implementations, AI technology can be used to perform image frame recognition on the preview screen corresponding to the view-finding region when capturing the first image to determine the horizon in the preview screen, and then obtain the first horizon information based on the position of the horizon in the preview screen.

The first horizon information can also be determined based on the first camera pose information. In some implementations, the first camera pose information can be determined by obtaining gyroscope data of the imaging apparatus and based on the calibrated pose of the gyroscope to characterize the pose of the imaging apparatus in actual physical space coordinates. The imaging apparatus has preset pose information and preset horizon information for a preset pose before leaving the factory. The preset horizon information can be converted based on the change between the first camera pose information and the preset pose information to obtain the first horizon information.

The gyroscope data of the imaging apparatus can also be directly analyzed to determine the first horizon information based on the analysis results.

In this implementation, the first horizon information is obtained through artificial intelligence recognition, based on gyroscope data of the imaging apparatus, or based on first camera pose information to achieve the acquisition of the first horizon information, allowing the first horizon information to characterize the current pose of the imaging apparatus as first orientation information, providing a basis for capturing the first image, ensuring exposure stability and consistency of the overlapping view-finding region in different images, enhancing user experience.

It should be noted that the first gravity direction information or the first forward direction information can also be obtained through artificial intelligence recognition. For example, AI technology can be used to perform image frame recognition on the preview screen corresponding to the view-finding region when capturing the first image to determine the gravity direction or forward direction in the preview screen, and then determine the first gravity direction information or first forward direction information based on the spatial rotation variation of the imaging apparatus relative to the gravity direction or forward direction at this time.

In some implementations, the imaging pose of the first image and the imaging pose of the second image are different poses of the imaging apparatus in the same imaging scene.

The imaging pose of the imaging apparatus for capturing the first image and the imaging pose for capturing the second image are different poses of the imaging apparatus in the same imaging scene, meaning that the first image and the second image are captured in the same imaging scene, allowing the view-finding region of the first image and the view-finding region of the second image to partially overlap. The environmental brightness when capturing the first image and the second image has not changed significantly, and the first image and the second image can capture the same target to be captured from different imaging angles through their respective corresponding imaging poses.

In some implementations, referring to FIG. 2, for example, in the same imaging scene, the imaging apparatus can be rotated along a specific direction to change the pose of the imaging apparatus, so that the imaging pose of the first image and the imaging pose of the second image are different poses of the imaging apparatus in the same imaging scene.

In this implementation, the imaging pose of the first image and the imaging pose of the second image are different poses of the imaging apparatus in the same imaging scene, allowing the first image and the second image of the same imaging scene to be captured, and ensuring exposure stability and consistency of the overlapping view-finding region in the first image and the second image under different imaging poses of the same imaging scene, ensuring the final image effect of the same imaging scene, enhancing user experience.

In some implementations, under the imaging pose of the first image and the imaging pose of the second image, the direction of a lens of the imaging apparatus is different.

Under the imaging pose of the first image and the imaging pose of the second image, the direction of a lens of the imaging apparatus can be different, meaning that the first image and the second image have different imaging angles. In some implementations, under the imaging pose of the first image and the imaging pose of the second image, the spatial unit vector characterizing the direction of the lens of the imaging apparatus is different.

In this implementation, under the imaging pose of the first image and the imaging pose of the second image, the direction of a lens of the imaging apparatus is different, allowing the first image and the second image to be captured with different lens directions, and ensuring exposure stability and consistency of the overlapping view-finding region in the first image and the second image under different lens directions, ensuring the final image effect under different lens directions, enhancing user experience.

In some implementations, under the imaging pose of the first image and the imaging pose of the second image, optical axes of a lens of the imaging apparatus are substantially parallel or form an included angle.

Under the imaging pose of the first image and the imaging pose of the second image, optical axes of a lens of the imaging apparatus can be substantially parallel, meaning that the direction of the lens of the imaging apparatus can be the same when capturing the first image and the second image, but the position of the imaging apparatus has changed. In some implementations, the spatial coordinates of the imaging apparatus under the imaging pose of the first image and the imaging pose of the second image are different, but the spatial unit vector characterizing the direction of the optical axis of the imaging apparatus is the same. The imaging apparatus can be moved along a specific direction while keeping the direction of the lens of the imaging apparatus unchanged, so that the optical axes of the lens of the imaging apparatus under the imaging pose of the first image and the imaging pose of the second image are substantially parallel.

Under the imaging pose of the first image and the imaging pose of the second image, optical axes of a lens of the imaging apparatus can form an included angle, meaning that the direction of the lens of the imaging apparatus is not the same when capturing the first image and the second image, but the position of the imaging apparatus has not changed. In some implementations, the spatial coordinates of the imaging apparatus under the imaging pose of the first image and the imaging pose of the second image are the same, but the spatial unit vector characterizing the direction of the optical axis of the imaging apparatus is different. The imaging apparatus can be rotated along a specific direction while keeping the position of the imaging apparatus unchanged, so that the optical axes of the lens of the imaging apparatus under the imaging pose of the first image and the imaging pose of the second image form an included angle.

In this implementation, under the imaging pose of the first image and the imaging pose of the second image, the optical axes of a lens of the imaging apparatus are set to be substantially parallel or form an included angle, allowing the first image and the second image to be captured with optical axes of the lens that are substantially parallel or form an included angle, and ensuring exposure stability and consistency of the overlapping view-finding region in the first image and the second image under changes in the optical axes of the lens of the imaging apparatus, ensuring the final image effect when the optical axes of the lens of the imaging apparatus change, enhancing user experience.

In some implementations, under the imaging pose of the first image and the imaging pose of the second image, if optical axes of a lens of the imaging apparatus form an included angle, the optical axes of the lens of the imaging apparatus are inclined in different directions relative to a horizontal plane.

Under the imaging pose of the first image and the imaging pose of the second image, if optical axes of a lens of the imaging apparatus form an included angle, the optical axes of the lens of the imaging apparatus are inclined in different directions relative to a horizontal plane. In some implementations, referring to FIG. 2, under the imaging pose of the first image and the imaging pose of the second image, the optical axes of the lens of the imaging apparatus form an included angle; under the imaging pose of the first image, the optical axis B of the lens of the imaging apparatus is inclined upwards relative to a horizontal plane; and under the imaging pose of the second image, the optical axis C of the lens of the imaging apparatus is inclined downwards relative to a horizontal plane.

In this implementation, by using two imaging poses where the optical axes of the lens of the imaging apparatus are inclined in different directions relative to a horizontal plane as the imaging pose of the first image and the imaging pose of the second image, the first image and the second image inclined in different directions relative to a horizontal plane can be obtained, so that the view-finding regions of the first image and the second image are located on both sides of the horizontal plane direction, and ensuring exposure stability and consistency of the overlapping view-finding region in the first image and the second image, ensuring the final image effect when the optical axes of the lens of the imaging apparatus are inclined in different directions relative to a horizontal plane, enhancing user experience.

In some implementations, under the imaging pose of the first image, an optical axis of a lens of the imaging apparatus forms an included angle with a gravity direction; or under the imaging pose of the second image, an optical axis of a lens of the imaging apparatus is substantially perpendicular to the gravity direction. It can also be that under the imaging pose of the first image, an optical axis of a lens of the imaging apparatus forms an included angle with a gravity direction, and under the imaging pose of the second image, an optical axis of a lens of the imaging apparatus is substantially perpendicular to the gravity direction.

Referring to FIG. 3, the actual physical coordinate space has an XYZ coordinate system (e.g., Cartesian coordinate system), with the gravity direction being the Z direction, and the optical axis of the lens of the imaging apparatus is P. Under the imaging pose of the first image, the optical axis P of the lens forms an included angle with the gravity direction, and the unit spatial vector of the optical axis P in the XYZ coordinate system can be (1, 0, 1).

Referring to FIG. 4, the actual physical coordinate space has the same XYZ coordinate system, with the gravity direction being the Z direction, and the optical axis of the lens of the imaging apparatus is P. Under the imaging pose of the second image, the optical axis P of the lens is substantially perpendicular to the gravity direction, and the unit spatial vector of the optical axis P in the XYZ coordinate system can be (1, 0, 0).

It can be understood that when the optical axis of the lens of the imaging apparatus forms an included angle with the gravity direction under the imaging pose of the first image, and is substantially perpendicular to the gravity direction under the imaging pose of the second image, the optical axis of the lens forms an included angle under the imaging poses of the first and second images, and is substantially parallel to the horizontal plane under the imaging pose of the second image.

In this implementation, by setting the optical axis of the lens of the imaging apparatus to form an included angle with the gravity direction under the imaging pose of the first image, and setting it to be substantially perpendicular to the gravity direction under the imaging pose of the second image, the optical axis of the lens forms an included angle under the imaging poses of the first and second images, and is substantially parallel to the horizontal plane under the imaging pose of the second image. The imaging pose of the second image can be used as the standard pose when the imaging apparatus is used normally, allowing the orientation information corresponding to the imaging pose of the second image to be used as standard orientation information. The first image can then be captured based on the standard orientation information and the first orientation information, ensuring that the brightness of the first region and the second region is substantially the same.

In some implementations, the view-finding region of the second image corresponds to a default light metering table, which is used for metering to determine exposure parameters when capturing images. As mentioned earlier, by setting the optical axis of the lens of the imaging apparatus to be substantially perpendicular to the gravity direction under the imaging pose of the second image, the optical axis of the lens is substantially parallel to the horizontal plane under the imaging pose of the second image. The imaging pose of the second image can be used as the standard pose when the imaging apparatus is used normally, meaning the imaging apparatus has a default light metering table under the standard pose.

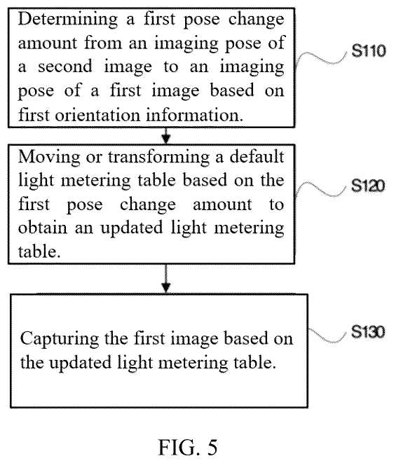

Referring to FIG. 5, capturing the first image based on the first orientation information includes:
S110: Determining a first pose change amount from an imaging pose of a second image to an imaging pose of a first image based on the first orientation information.

In operation S110, a first pose change amount from the imaging pose of the second image to the imaging pose of the first image is determined based on the first orientation information. The first pose change amount can characterize the pose change amount of the imaging apparatus from the imaging pose of the second image to the imaging pose of the first image, allowing the first pose change amount to represent the pose change amount of the imaging apparatus from the standard pose to the imaging pose of the first image. In some implementations, the first pose change amount can be a rotational change amount.
S120: Moving or transforming a default light metering table based on the first pose change amount to obtain an updated light metering table.

In operation S120, based on the first pose change amount, the default light metering table can be moved or transformed. Moving the default light metering table represents translating and replacing the light metering weights in the default light metering table within the same metering range based on the first pose change amount. Transforming the default light metering table represents converting the light metering weights in the default light metering table based on a certain correspondence relationship according to the first pose change amount to obtain an updated light metering table with updated light metering weights.

It can be understood that since the default light metering table corresponding to the standard pose is moved or transformed based on the first pose change amount to obtain the updated light metering table, the overlapping view-finding region can have substantially the same light metering weights in both the default light metering table and the updated light metering table, ensuring that the brightness of the first region of the first image and the second region of the second image is substantially the same.
S130: Capturing the first image based on the updated light metering table.

In operation S130, the updated light metering table can be used as the light metering table for capturing the first image, and the exposure parameters under the imaging pose of the first image can be determined based on the metering results corresponding to the updated light metering table. The first image can then be captured based on the determined exposure parameters.

In this implementation, the first pose change amount from the imaging pose of the second image to the imaging pose of the first image is determined based on the first orientation information, and the default light metering table is moved or transformed based on the first pose change amount to obtain the updated light metering table, allowing the first image to be captured based on the updated light metering table. By using the imaging pose of the second image as the standard pose, the default light metering table is moved or transformed based on the first pose change amount from the standard pose to the imaging pose of the first image, ensuring that the overlapping view-finding region has substantially the same light metering weights in both the default light metering table and the updated light metering table, achieving substantially the same brightness for the first region and the second region, ensuring exposure stability and consistency of the overlapping view-finding region in different images, enhancing user experience.

In some implementations, before capturing the first image based on the first orientation information in response to the first imaging trigger operation, the imaging method further includes: capturing the second image based on the second orientation information in response to a second imaging trigger operation.

The second imaging operation is the same as the first imaging operation, both being operations made by the user to control the imaging apparatus to capture images. In some implementations, the second imaging trigger operation can be an operation such as the user pressing the capture button or clicking the capture control in the interactive interface.

When the imaging apparatus recognizes the second imaging trigger operation, it captures the second image based on the second orientation information. The second orientation information is used to characterize the current pose of the imaging apparatus during the capturing of the second image based on reference information. The second orientation information can be relevant information of the imaging pose of the imaging apparatus in actual physical coordinate space, and the reference information at this time can be relevant information of the calibrated pose of the imaging apparatus in actual physical space. The second orientation information can also be relevant information of the relative pose of the imaging apparatus with a preset reference object, and the reference information at this time can be relevant information of the preset reference object. The second orientation information changes synchronously when the imaging apparatus is in different imaging poses.

As mentioned earlier, the capturing of the second image is performed before the capturing of the first image. The view-finding regions of the imaging apparatus under the imaging poses of the first image and the second image partially overlap. The overlapping view-finding region corresponds to the first region and the second region in the first image and the second image, respectively. Capturing the second image based on the second orientation information and then capturing the first image based on the first orientation information ensures that the brightness of the first region of the first image and the second region of the second image is substantially the same, thereby ensuring that the brightness of the overlapping region in the first image and the second image is substantially the same.

In this implementation, before capturing the first image based on the first orientation information in response to the first imaging trigger operation, capturing the second image based on the second orientation information when the second imaging trigger operation is recognized ensures that the brightness of the first region of the first image and the second region of the second image is substantially the same when the imaging poses of the first image and the second image are different, ensuring exposure stability and consistency of the overlapping view-finding region in different images, which is conducive to subsequent processing such as panoramic image synthesis and target tracking with multiple images captured in different imaging poses, enhancing user experience.

In some implementations, capturing the second image based on the second orientation information in response to the second imaging trigger operation includes: adjusting current exposure parameters of the imaging apparatus based on the second orientation information to obtain the second image. Capturing the first image based on the first orientation information in response to the first imaging trigger operation includes: adjusting current exposure parameters of the imaging apparatus based on the first orientation information to obtain the first image, where the brightness of the first region and the brightness of the second region both correspond to the brightness of a current imaging scene.

When capturing the second image based on the second orientation information, the current exposure parameters of the imaging apparatus can be adjusted based on the second orientation information. The current exposure parameters can include parameters affecting the exposure effect such as exposure time or exposure gain. The parameter values of the current exposure parameters before adjustment can be preset values or parameter values from the last capture. After adjusting the current exposure parameters of the imaging apparatus, the image brightness of the second image can correspond to the adjusted exposure parameters.

When capturing the first image based on the first orientation information, the current exposure parameters of the imaging apparatus can be adjusted based on the first orientation information. The current exposure parameters before adjustment can be preset values or parameter values when capturing the second image. After adjusting the current exposure parameters of the imaging apparatus, the image brightness of the first image can correspond to the adjusted exposure parameters.

The second image and the first image are obtained by adjusting the current exposure parameters based on the second orientation information and the first orientation information, respectively, ensuring that the brightness of the first region of the first image and the second region of the second image both correspond to the brightness of the current imaging scene. In some implementations, the image captured by the imaging apparatus in the standard pose can correspond to the brightness of the current imaging scene, and the imaging apparatus has corresponding parameter values of the exposure parameters in the standard pose. The pose change amounts from the standard pose to the imaging pose of the second image and the imaging pose of the first image can be determined based on the second orientation information and the first orientation information, respectively, and the current exposure parameters can be adjusted based on the pose change amounts determined by the first orientation information and the second orientation information, ultimately ensuring that the brightness of the first region of the first image and the second region of the second image both correspond to the brightness value of the current imaging scene.

In this implementation, adjusting the current exposure parameters based on the second orientation information and the first orientation information to obtain the second image and the first image, respectively, allows the brightness of the first region of the first image and the second region of the second image to both correspond to the brightness of the current imaging scene through the adjustment of the current exposure parameters, ensuring exposure stability and consistency of the overlapping view-finding region in different images, and ensuring that the brightness of the overlapping view-finding region can remain consistent with the real imaging scene, enhancing the imaging effect and fidelity of the first image and the second image.

In some implementations, the second orientation information includes any one or any combination of a plurality of types of second camera pose information, second horizon information, second gravity direction information, or second forward direction information.

The second orientation information can characterize the current pose of the imaging apparatus during the capturing of the second image. The second orientation information can be second camera pose information, which can characterize the imaging pose of the imaging apparatus in actual physical space coordinates. For example, the second camera pose information can be determined by obtaining gyroscope data of the imaging apparatus and based on the preset calibrated pose, i.e., the calibrated pose of the gyroscope.

The second orientation information can also be second horizon information, which can characterize the position of the horizon in the view-finding region under the imaging pose of the second image, allowing the horizon to be used as a reference to characterize the relative pose of the imaging apparatus with the horizon through the second horizon information, so that the second horizon information can characterize the current pose of the imaging apparatus as second orientation information.

The second orientation information can also be second gravity direction information or second forward direction information. The second gravity direction information can characterize the spatial rotation variation of the imaging apparatus relative to the gravity direction under the imaging pose of the second image. The second forward direction information can characterize the spatial rotation variation of the imaging apparatus relative to the forward direction, i.e., the horizontal direction, under the imaging pose of the second image. The gravity direction or forward direction can be used as a reference direction to characterize the relative pose of the imaging apparatus with the gravity direction or forward direction through the second gravity direction information or second forward direction information, so that the second gravity direction information or second forward direction information can characterize the current pose of the imaging apparatus as second orientation information.

In this implementation, any one or any combination of second camera pose information, second horizon information, second gravity direction information, or second forward direction information is used as second orientation information, allowing the imaging pose of capturing the second image to be characterized by the imaging pose of the imaging apparatus in actual physical space coordinates and the relative pose information with a preset reference object or preset reference direction, providing a basis for capturing the second image, ensuring exposure stability and consistency of the overlapping view-finding region in different images, enhancing user experience.

In some implementations, the acquisition method of the second horizon information includes: obtaining the second horizon information through artificial intelligence recognition; or determining the second horizon information based on the second camera pose information; or determining the second horizon information based on gyroscope data of the imaging apparatus.

The second horizon information can be obtained through Artificial Intelligence (AI) recognition. In some implementations, AI technology can be used to perform image frame recognition on the preview screen corresponding to the view-finding region when capturing the second image to determine the horizon in the preview screen, and then obtain the second horizon information based on the position of the horizon in the preview screen.

The second horizon information can also be determined based on the second camera pose information. In some implementations, the second camera pose information can be determined by obtaining gyroscope data of the imaging apparatus and based on the calibrated pose of the gyroscope to characterize the pose of the imaging apparatus in actual physical space coordinates. The imaging apparatus has preset pose information and preset horizon information for a preset pose before leaving the factory. The preset horizon information can be converted based on the change between the second camera pose information and the preset pose information to obtain the second horizon information.

The gyroscope data of the imaging apparatus can also be directly analyzed to determine the second horizon information based on the analysis results.

In this implementation, the second horizon information is obtained through artificial intelligence recognition, based on gyroscope data of the imaging apparatus, or based on second camera pose information to achieve the acquisition of the second horizon information, allowing the second horizon information to characterize the current pose of the imaging apparatus as second orientation information, providing a basis for capturing the second image, ensuring exposure stability and consistency of the overlapping view-finding region in different images, enhancing user experience.

It should be noted that the second gravity direction information or the second forward direction information can also be obtained through artificial intelligence recognition. For example, AI technology can be used to perform image frame recognition on the preview screen corresponding to the view-finding region when capturing the second image to determine the gravity direction or forward direction in the preview screen, and then determine the second gravity direction information or second forward direction information based on the spatial rotation variation of the imaging apparatus relative to the gravity direction or forward direction at this time.

In some implementations, referring to FIG. 6, capturing the second image based on the second orientation information in response to the second imaging trigger operation includes:
S200: Determining first correction light metering information based on second orientation information and preset light metering information.

In operation S200, when the second imaging trigger operation made by the user is recognized, the first correction light metering information is determined based on the second orientation information and preset light metering information. The preset light metering information and the first correction light metering information are relevant information used by the imaging apparatus for metering to determine exposure parameters. The preset light metering information can correspond to preset pose information. In some implementations, the preset light metering information can include a preset light metering table, and the first correction light metering information can include a first light metering table. The preset light metering table can be set in advance based on metering requirements or experience before the imaging apparatus is manufactured and shipped.
S300: Performing image exposure based on the first correction light metering information to obtain a second image.

In operation S300, image exposure can be performed based on the first correction light metering information to obtain the second image corresponding to the second orientation information, achieving the capturing of the second image based on the second orientation information. Since the first correction light metering information is determined based on the second orientation information and the preset light metering information, the change in light metering information between the preset light metering information and the first correction light metering information can correspond to the change in current pose characterized between the preset pose information and the second orientation information.

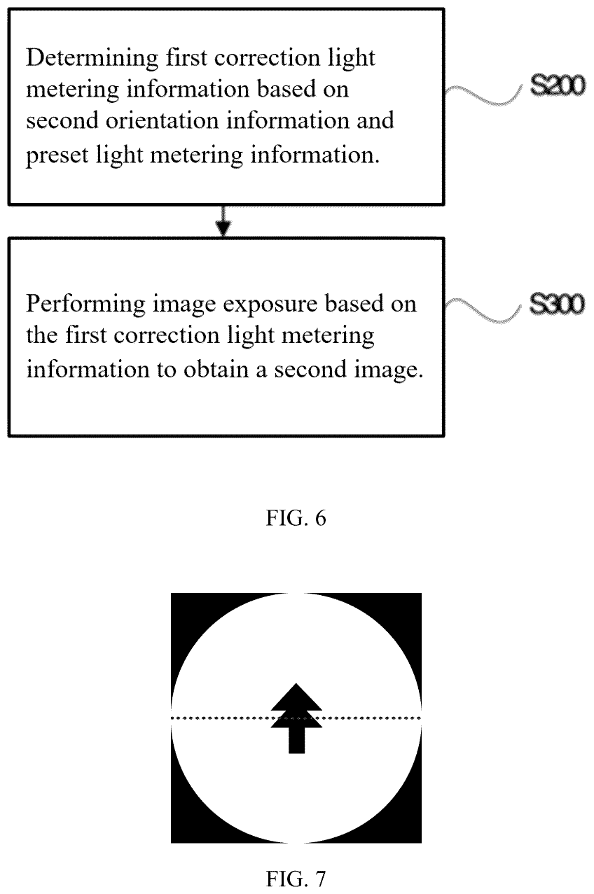

In some implementations, the second orientation information is second horizon information. When capturing the second image, the view-finding region is as shown in FIG. 7, where the dashed line represents the horizon in the view-finding region of the second image. The first light metering table can be determined based on the second horizon information and preset light metering information, and image exposure can be performed based on the first light metering table to obtain the second image.

Referring to FIG. 8, capturing the first image based on the first orientation information in response to the first imaging trigger operation includes:
S400: Determining second correction light metering information based on first orientation information and preset light metering information.

In operation S400, when the first imaging trigger operation made by the user is recognized, the second correction light metering information is determined based on the first orientation information and preset light metering information. The preset light metering information and the second correction light metering information are relevant information used by the imaging apparatus for metering to determine exposure parameters. In some implementations, the first correction light metering information can include a second light metering table.
S500: Performing image exposure based on the second correction light metering information to obtain a first image.

In operation S500, image exposure can be performed based on the second correction light metering information to obtain the first image corresponding to the first orientation information, achieving the capturing of the first image based on the first orientation information. Since the second correction light metering information is determined based on the first orientation information and the preset light metering information, the change in light metering information between the preset light metering information and the second correction light metering information can correspond to the change in current pose characterized between the preset pose information and the first orientation information.

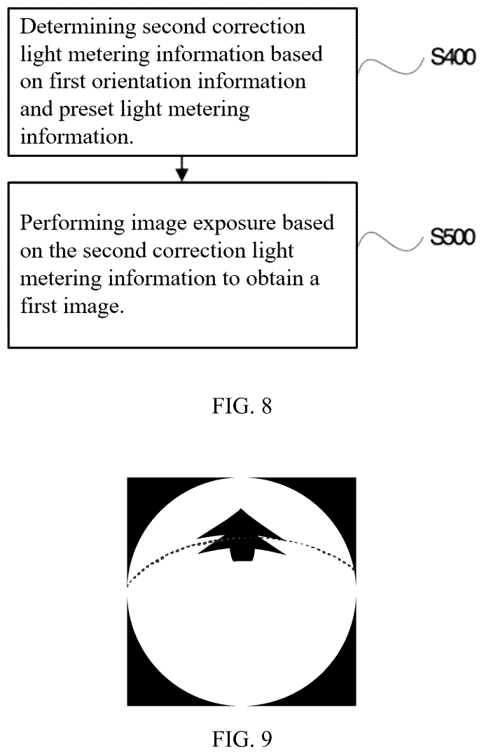

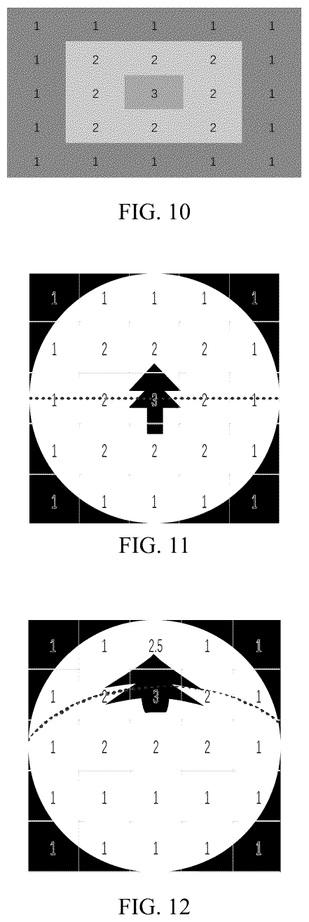

In some implementations, the first orientation information is first horizon information. When capturing the first image, the view-finding region is as shown in FIG. 9, where the dashed line represents the horizon in the view-finding region of the first image. The second light metering table can be determined based on the first horizon information and preset light metering information, and image exposure can be performed based on the second light metering table to obtain the first image.

It can be understood that since the change in light metering information between the preset light metering information and the first correction light metering information corresponds to the change in current pose characterized between the preset pose information and the second orientation information, and the change in light metering information between the preset light metering information and the second correction light metering information corresponds to the change in current pose characterized between the preset pose information and the first orientation information, i.e., the determination of the first correction light metering information and the second correction light metering information is based on the same preset correction light metering information, ensuring that the corresponding first correction light metering information and second correction light metering information of the overlapping view-finding region is substantially the same, thereby ensuring that the brightness of the first region of the first image and the second region of the second image is substantially the same.

In this implementation, the first correction light metering information is determined based on the second orientation information and preset light metering information, and image exposure is performed based on the first correction light metering information to obtain the second image corresponding to the second orientation information. Then, the second correction light metering information is determined based on the first orientation information and preset light metering information, and image exposure is performed based on the second correction light metering information to obtain the first image corresponding to the first orientation information, achieving the capturing of the second image and the first image based on the second orientation information and the first orientation information, respectively. The determination of the first correction light metering information and the second correction light metering information is based on the same preset correction light metering information, ensuring that the brightness of the first region of the first image and the second region of the second image is substantially the same, ensuring exposure stability and consistency of the overlapping view-finding region in different images, enhancing user experience.

In some implementations, the preset light metering information includes a preset light metering table, which is configured to characterize preset light metering weights corresponding to a plurality of light metering sub-regions into which a light metering region of the imaging apparatus is divided. The first correction light metering information includes a first light metering table, which is configured to characterize first light metering weights corresponding to the plurality of light metering sub-regions. The second correction light metering information includes a second light metering table, which is configured to characterize second light metering weights corresponding to the plurality of light metering sub-regions.

The preset light metering information includes a preset light metering table, which can characterize preset light metering weights corresponding to a plurality of light metering sub-regions into which a light metering region of the imaging apparatus is divided. The light metering region of the imaging apparatus is a specific region selected by the imaging apparatus when determining exposure, and the light metering region of the imaging apparatus can be the same as the imaging region of the imaging apparatus. The preset light metering weight represents the degree of influence of the corresponding light metering sub-region on the final exposure parameters when initially determining exposure. In some implementations, referring to FIG. 10, the preset light metering table can include 5*5 light metering sub-regions of the same shape and size, each having corresponding preset light metering weights.

The first correction light metering information includes a first light metering table, which can characterize first light metering weights corresponding to the plurality of light metering sub-regions into which the light metering region of the imaging apparatus is divided. The first light metering weight represents the degree of influence of the corresponding light metering sub-region on the final exposure parameters when determining exposure before capturing the second image. In some implementations, if the imaging pose of the second image is the same as the preset pose, the correspondence relationship between the first light metering table determined based on the second orientation information and the view-finding region of the second image is as shown in FIG. 11.

The second correction light metering information includes a second light metering table, which can characterize second light metering weights corresponding to the plurality of light metering sub-regions into which the light metering region of the imaging apparatus is divided. The second light metering weight represents the degree of influence of the corresponding light metering sub-region on the final exposure parameters when determining exposure before capturing the first image. In some implementations, if the imaging pose of the first image changes relative to the imaging pose of the second image, the correspondence relationship between the second light metering table determined based on the first orientation information and the view-finding region of the first image is shown in FIG. 12.

In this implementation, the preset light metering information, first correction light metering information, and second correction light metering information include the preset light metering table, first light metering table, and second light metering table, respectively. The preset light metering table, first light metering table, and second light metering table can characterize preset light metering weights, first light metering weights, and second light metering weights corresponding to each light metering sub-region, respectively. The first light metering weights and second light metering weights can characterize the degree of influence of each light metering sub-region on the final exposure parameters when determining exposure before capturing the second image and the first image, respectively, providing a basis for determining exposure of the second image and the first image, thereby achieving the capturing of the second image and the first image, and ensuring that the brightness of the first region of the first image and the second region of the second image is substantially the same, ensuring exposure stability and consistency of the overlapping view-finding region in different images, enhancing user experience.

In some implementations, the preset light metering weight corresponding to a light metering sub-region at the center of the light metering region is greater than the preset light metering weight of a light metering sub-region at the edge of the light metering region.

Referring to FIG. 10, the preset light metering weight corresponding to a light metering sub-region at the center of the light metering region is greater than the preset light metering weight of a light metering sub-region at the edge of the light metering region. That is, the closer the light metering sub-region is to the center position of the light metering region, the greater the preset light metering weight corresponding to the light metering sub-region, indicating a greater influence on the final exposure parameters when initially determining exposure for light metering sub-regions near the center position.

In this implementation, by setting the preset light metering weight corresponding to the light metering sub-region at the center of the light metering region to be greater than that of the light metering sub-region at the edge, it ensures that during initial exposure determination, the light metering sub-regions near the center have a greater influence on the final exposure parameters. This ensures that the imaging apparatus can use the metering result corresponding to the center position of the view-finding region as the basis for determining the final exposure parameters in the standard preset pose, thereby ensuring that the image brightness during imaging in the preset pose can be consistent with the environmental brightness corresponding to the center position of the view-finding region. This enhances the imaging effect of the first and second images when the preset light metering table is used as the basis for determining the first and second light metering tables.

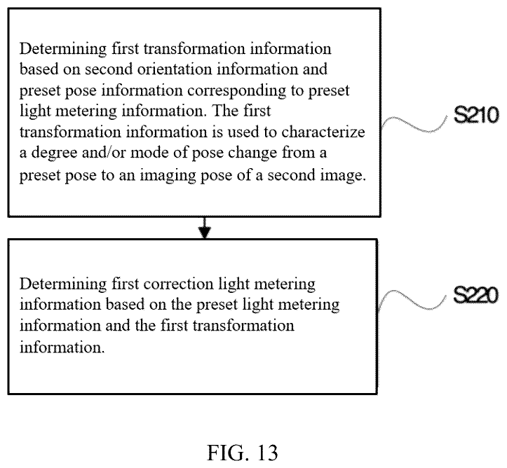

In some implementations, referring to FIG. 13, determining the first correction light metering information based on the second orientation information and preset light metering information includes:
S210: Determining first transformation information based on second orientation information and preset pose information corresponding to the preset light metering information. The first transformation information is used to characterize a degree and/or mode of pose change from a preset pose to an imaging pose of a second image.

In operation S210, the preset light metering information has corresponding preset pose information, which characterizes the preset pose of the imaging apparatus. The preset pose is the standard pose of the imaging apparatus during normal use and can be set according to the usage requirements or applicable imaging scenes of the imaging apparatus. The preset pose information and preset light metering information corresponding to the preset pose are set before the imaging apparatus is shipped. In some implementations, the preset pose information can be preset horizon information, which can characterize the position of the horizon in the standard view-finding region under the preset pose.

The first transformation information can be determined based on the second orientation information and the preset pose information corresponding to the preset light metering information. The first transformation information can characterize the degree and mode of pose change from the standard preset pose to the imaging pose of the second image. In some implementations, the first transformation information can characterize the pose change from the preset pose to the imaging pose of the second image as any one of translation change, rotation change, or a combination of translation change and rotation change, and can characterize the direction of translation change, the rotation axis around which the rotation change occurs, and the amounts of translation and rotation changes.
S220: Determining first correction light metering information based on the preset light metering information and the first transformation information.

In operation S220, the preset light metering information can be corrected based on the first transformation information to obtain the first correction light metering information. In some implementations, when the first transformation information characterizes the pose change from the preset pose to the imaging pose of the second image as a rotation change mode with a corresponding rotation direction and angle, the preset light metering weights of each light metering sub-region characterized by the preset light metering table can be corrected based on the rotation direction and angle to obtain the corrected first light metering weights corresponding to each light metering sub-region, thereby determining the first light metering table.

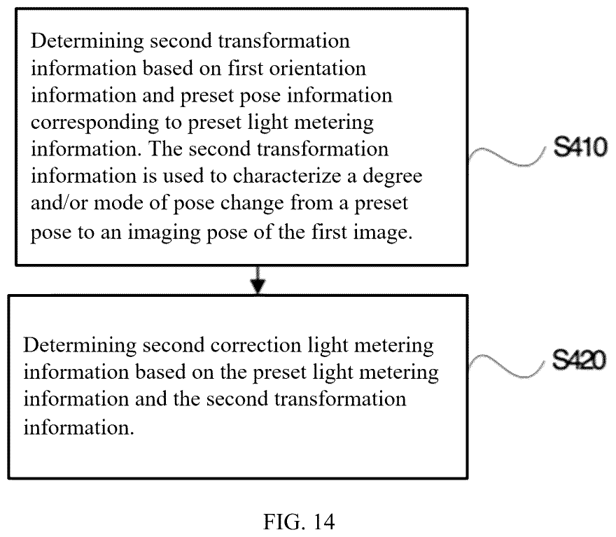

Referring to FIG. 14, determining the second correction light metering information based on the first orientation information and preset light metering information includes:
S410: Determining second transformation information based on first orientation information and preset pose information corresponding to preset light metering information. The second transformation information is used to characterize a degree and/or mode of pose change from a preset pose to an imaging pose of the first image.

In operation S410, the second transformation information can be determined based on the first orientation information and the preset pose information corresponding to the preset light metering information. The second transformation information can characterize the degree and mode of pose change from the standard preset pose to the imaging pose of the first image. In some implementations, the second transformation information can characterize the pose change from the preset pose to the imaging pose of the first image as any one of translation change, rotation change, or a combination of translation and rotation changes, and can characterize the direction of translation change, the rotation axis around which the rotation change occurs, and the amounts of translation and rotation changes.
S420: Determining second correction light metering information based on the preset light metering information and the second transformation information.

In operation S420, the preset light metering information can be corrected based on the second transformation information to obtain the second correction light metering information. In some implementations, when the second transformation information characterizes the pose change from the preset pose to the imaging pose of the first image as a rotation change mode with a corresponding rotation direction and angle, the preset light metering weights of each light metering sub-region characterized by the preset light metering table can be corrected based on the rotation direction and angle to obtain the corrected second light metering weights corresponding to each light metering sub-region, thereby determining the second light metering table.

In this implementation, the first transformation information is determined based on the second orientation information and the preset pose information corresponding to the preset light metering information, allowing the preset light metering information to be corrected based on the first transformation information to obtain the first correction light metering information. The second transformation information is determined based on the first orientation information and the preset pose information corresponding to the preset light metering information, allowing the preset light metering information to be corrected based on the second transformation information to obtain the second correction light metering information, thereby achieving the determination of the first and second correction light metering information. Using the first and second transformation information as the basis for determining the first and second correction light metering information, respectively, allows the correction process of light metering information under different imaging poses to correspond to the pose change between the imaging pose and the preset pose, thereby ensuring that the brightness of the first region of the first image and the second region of the second image is substantially the same, ensuring exposure stability and consistency of the overlapping view-finding region in different images, enhancing user experience.

In some implementations, under the preset pose, the optical axis of a lens of the imaging apparatus is in a horizontal direction.

The pose with the optical axis of the lens of the imaging apparatus in a horizontal direction is used as the preset pose of the imaging apparatus. The preset pose information and preset light metering information both correspond to this preset pose. Under this preset pose, the horizon characterized by the preset horizon information can be located in the middle position of the view-finding region, allowing most of the target to be captured to be located in the central area of the view-finding region when capturing the target. If the preset light metering weight corresponding to the light metering sub-region at the center of the light metering region is set to be greater than that of the light metering sub-region at the edge, it can ensure the brightness effect of the target to be captured in the image captured under this preset pose.

In this implementation, by using the pose with the optical axis of the lens of the imaging apparatus in a horizontal direction as the preset pose of the imaging apparatus, the preset pose information and preset light metering information corresponds to this preset pose, ensuring the applicability and imaging effect of the preset light metering information. This allows the first correction light metering information and second correction light metering information determined based on the preset light metering information to be adapted to the imaging poses of the second and first images, respectively, ensuring exposure stability and consistency of the overlapping view-finding region in different images, enhancing user experience.

In some implementations, determining the first correction light metering information based on the preset light metering information and the first transformation information includes: determining the first correction light metering information based on the first transformation information and preset configuration information corresponding to the preset light metering information. The preset configuration information is used to characterize the correspondence between the degree and/or mode of pose change and the light metering information after the pose change.

The preset light metering information has corresponding preset configuration information, which can characterize the light metering information corresponding to the preset light metering information after undergoing a certain degree and mode of pose change. The preset configuration information includes the mapping relationship between different degrees and modes of pose change and light metering information. In some implementations, the preset configuration information can be a specific algorithm considering horizon distortion. Based on the degree and mode of pose change characterized by the first transformation information, the first correction light metering information can be determined by correcting the preset light metering information through the preset configuration information after the imaging apparatus undergoes the pose change from the preset pose to the imaging pose of the second image.

Determining the second correction light metering information based on the preset light metering information and the second transformation information includes: determining the second correction light metering information based on the second transformation information and preset configuration information corresponding to the preset light metering information.

Based on the degree and mode of pose change characterized by the second transformation information, the second correction light metering information can be determined by correcting the preset light metering information through the preset configuration information after the imaging apparatus undergoes the pose change from the preset pose to the imaging pose of the first image.

In this implementation, the first correction light metering information is determined based on the preset configuration information corresponding to the preset light metering information and the first transformation information, and the second correction light metering information is determined based on the preset configuration information and the second transformation information, achieving the determination of the first correction light metering information and the second correction light metering information, providing a basis for the exposure of the second and first images. The preset configuration information can characterize the correspondence between the mode and degree of pose change and the corrected light metering information, allowing the corrected first correction light metering information to be adapted to the pose change from the preset pose to the imaging pose of the second image, and the second correction light metering information to be adapted to the pose change from the preset pose to the imaging pose of the first image, ensuring exposure stability and consistency of the overlapping view-finding region in different images, enhancing user experience.

In some implementations, the first transformation information includes a pose change amount of the imaging apparatus along a first preset direction. Determining the first correction light metering information based on the preset light metering information and the first transformation information includes: if the pose change amount of the imaging apparatus along the first preset direction is in a first preset range, translating and replacing the preset light metering weights of the plurality of light metering sub-regions along a reverse direction of the first preset direction to obtain the first correction light metering information.

As mentioned earlier, the first transformation information can characterize the degree and mode of pose change from the preset pose to the imaging pose of the second image. When the pose change mode is a translation change and the pose change amount is a displacement amount, the first transformation information can include a pose change amount of the imaging apparatus along a first preset direction. When the pose change amount of the imaging apparatus along the first preset direction is within the first preset range, i.e., when the displacement amount from the preset pose to the imaging pose of the second image along the first preset direction is within the corresponding preset range, the preset light metering weights of each light metering sub-region can be translated and replaced along the reverse direction of the first preset direction to obtain the first correction light metering information corresponding to the imaging pose of the second image.

In some implementations, the first preset direction can be the gravity direction. When the imaging apparatus moves downward along the gravity direction and the displacement amount along the gravity direction is within the first preset range, the preset light metering weights of each light metering sub-region can be translated and replaced along the reverse direction of the gravity direction, i.e., the vertical upward direction, so that the preset light metering weight of each light metering sub-region is corrected to the preset light metering weight of the adjacent lower light metering sub-region, serving as the first light metering weight corresponding to that light metering sub-region, thereby obtaining the first light metering table.

The second transformation information includes a pose change amount of the imaging apparatus along a second preset direction. Determining the second correction light metering information based on the preset light metering information and the second transformation information includes: if the pose change amount of the imaging apparatus along the second preset direction is in a second preset range, translating and replacing the preset light metering weights of the plurality of light metering sub-regions along a reverse direction of the second preset direction to obtain the second correction light metering information.

When the pose change amount of the imaging apparatus along the second preset direction is in the second preset range, i.e., when the displacement amount from the preset pose to the imaging pose of the first image along the second preset direction is within the corresponding preset range, the preset light metering weights of each light metering sub-region can be translated and replaced along the reverse direction of the second preset direction to obtain the second correction light metering information corresponding to the imaging pose of the first image. In some implementations, the first preset direction and the second preset direction can be the same direction, and the first preset range and the second preset range can have the same starting and ending values.

In this implementation, when the pose change amount of the imaging apparatus along the first preset direction is in the first preset range, the preset light metering weights of each light metering sub-region can be translated and replaced along the reverse direction of the first preset direction to obtain the first correction light metering information corresponding to the imaging pose of the second image. When the pose change amount of the imaging apparatus along the second preset direction is in the second preset range, the preset light metering weights of each light metering sub-region can be translated and replaced along the reverse direction of the second preset direction to obtain the second correction light metering information corresponding to the imaging pose of the first image, achieving the determination of the first and second correction light metering information, providing a basis for the exposure of the second and first images. By translating and replacing the preset light metering weights, the overlapping view-finding region can have substantially the same light metering weights, ensuring that the brightness of the first region of the first image and the second region of the second image is substantially the same, ensuring exposure stability and consistency of the overlapping view-finding region in different images, enhancing user experience.

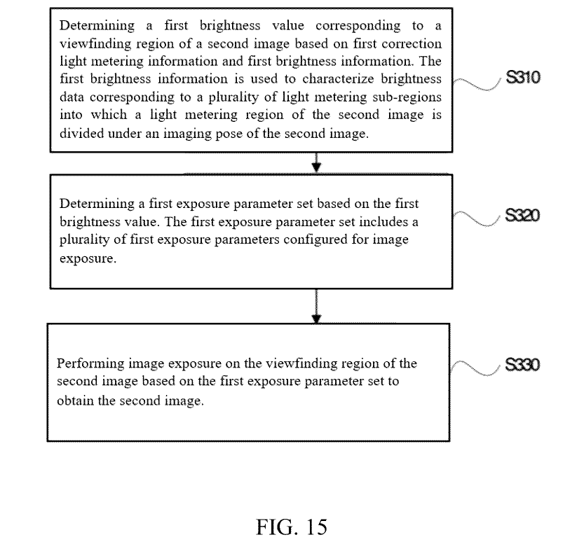

In some implementations, referring to FIG. 15, performing image exposure based on the first correction light metering information to obtain the second image includes:
S310: Determining a first brightness value corresponding to a view-finding region of a second image based on the first correction light metering information and first brightness information. The first brightness information is used to characterize brightness data corresponding to a plurality of light metering sub-regions into which a light metering region of the second image is divided under an imaging pose of the second image.

In operation S310, the first brightness information is used to characterize brightness data corresponding to the plurality of light metering sub-regions under the imaging pose of the second image. The quantity of brightness data characterized by the first brightness information can be the same as the number of light metering sub-regions. When the light metering region is divided into 5*5 light metering sub-regions, the brightness data characterized by the first brightness information can be 5*5. The first brightness information can be obtained through an Image Signal Processor (ISP) of the imaging apparatus.

The first brightness value corresponding to the view-finding region of the second image can be calculated based on the first correction light metering information and the first brightness information using an automatic exposure algorithm. The first brightness value can be the current brightness value (luma) corresponding to the view-finding region of the second image. By determining the first brightness value corresponding to the view-finding region of the second image, the exposure determination process under the imaging pose of the second image is completed.
S320: Determining a first exposure parameter set based on the first brightness value. The first exposure parameter set includes a plurality of first exposure parameters configured for image exposure.

In operation S320, the first exposure parameter set can be determined based on the first brightness value using an automatic exposure algorithm. By determining the first exposure parameter set, the process of determining the exposure parameters under the imaging pose of the second image is completed. The first exposure parameter set includes a plurality of first exposure parameters configured for image exposure.
S330: Performing image exposure on the view-finding region of the second image based on the first exposure parameter set to obtain the second image.

In operation S330, the view-finding region of the second image is exposed based on the obtained first exposure parameter set as the basis for image exposure, obtaining the second image and completing the image exposure, i.e., capturing process of the second image.

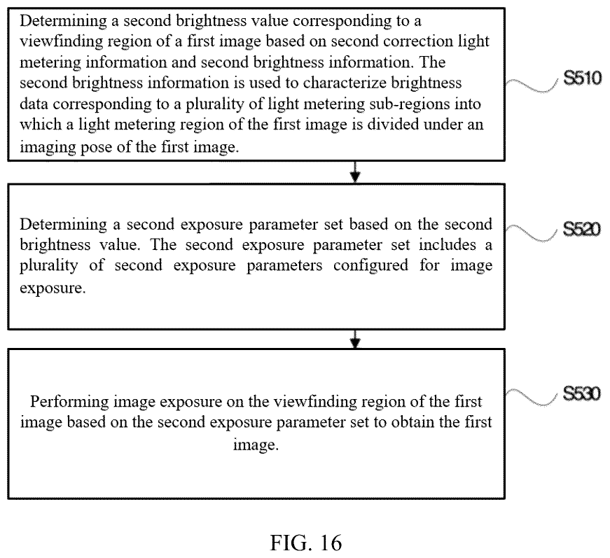

Referring to FIG. 16, performing image exposure based on the second correction light metering information to obtain the first image includes:
S510: Determining a second brightness value corresponding to a view-finding region of a first image based on second correction light metering information and second brightness information. The second brightness information is used to characterize brightness data corresponding to a plurality of light metering sub-regions into which a light metering region of the first image is divided under an imaging pose of the first image.

In operation S510, the second brightness information is configured to characterize brightness data corresponding to the plurality of light metering sub-regions under the imaging pose of the first image. The quantity of brightness data characterized by the second brightness information can be the same as the number of light metering sub-regions. When the light metering region is divided into 5*5 light metering sub-regions, the brightness data characterized by the second brightness information can be 5*5. The second brightness information can be obtained through an Image Signal Processor (ISP) of the imaging apparatus.

The second brightness value corresponding to the view-finding region of the first image can be calculated based on the second correction light metering information and the second brightness information using an automatic exposure algorithm. The second brightness value can be the current brightness value (luma) corresponding to the view-finding region of the first image. By determining the second brightness value corresponding to the view-finding region of the first image, the exposure determination process under the imaging pose of the first image is completed.
S520: Determining a second exposure parameter set based on the second brightness value. The second exposure parameter set includes a plurality of second exposure parameters configured for image exposure.

In operation S520, the second exposure parameter set can be determined based on the second brightness value using an automatic exposure algorithm. By determining the second exposure parameter set, the process of determining the exposure parameters under the imaging pose of the first image is completed. The second exposure parameter set includes a plurality of second exposure parameters configured for image exposure.
S530: Performing image exposure on the view-finding region of the first image based on the second exposure parameter set to obtain the first image.

In operation S530, the view-finding region of the first image is exposed based on the obtained second exposure parameter set as the basis for image exposure, obtaining the first image and completing the image exposure, i.e., capturing process of the first image.

In this implementation, the corresponding brightness values are determined based on the corresponding light metering information and brightness information under the imaging poses of the first and second images, respectively, and the corresponding exposure parameter sets are determined based on the corresponding brightness values. Image exposure can be performed using the corresponding exposure parameters to achieve the capturing of the first and second images, respectively. By determining the exposure parameter sets under the imaging poses of the first and second images, the exposure effects under different poses can be changed using different exposure parameter sets, ensuring that the brightness of the first region of the first image and the second region of the second image is substantially the same, ensuring exposure stability and consistency of the overlapping view-finding region in different images, enhancing user experience.

In some implementations, the imaging method further includes: determining the preset light metering information based on a preset custom operation of a user; or determining one of a plurality of pieces of initial light metering information as the preset light metering information based on a preset selection operation of a user.

The preset light metering information can be determined based on a preset custom operation of a user. In some implementations, the user can define the preset light metering weights corresponding to each light metering sub-region characterized by the preset light metering table through a preset custom operation, thereby determining the preset light metering information, allowing the preset light metering information to be adapted to the metering requirements under the preset pose. The preset light metering information can also be determined based on a preset selection operation of a user. In some implementations, the imaging apparatus has initial light metering information applicable to different metering requirements or imaging scenes under the same preset pose. The user can select one of the plurality of pieces of initial light metering information as the preset light metering information through a preset selection operation, thereby determining the preset light metering information, allowing the preset light metering information to be adapted to the metering requirements under the preset pose.

In this implementation, the preset light metering information is determined based on a preset custom operation or a preset selection operation of a user, allowing the user to define or select the preset light metering information according to metering requirements. The preset light metering information can be adjusted for adaptability to the imaging scene to ensure that the preset light metering information can be adapted to the metering requirements under the preset pose of the current imaging scene, thereby ensuring the imaging effect of the first and second images and enhancing user experience.

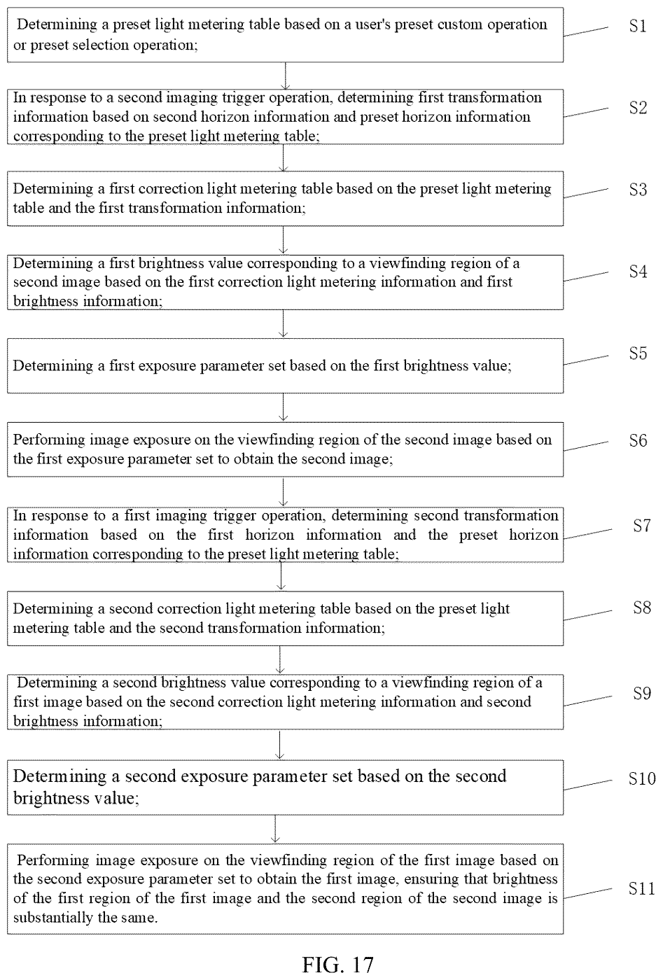

In an implementation, an imaging method is provided, applied to an imaging apparatus. Referring to FIG. 17, the imaging method includes:
S1: Determining a preset light metering table based on a user's preset custom operation or preset selection operation;
S2: In response to a second imaging trigger operation, determining first transformation information based on second horizon information and preset horizon information corresponding to the preset light metering table;
S3: Determining a first correction light metering table based on the preset light metering table and the first transformation information;
S4: Determining a first brightness value corresponding to a view-finding region of a second image based on the first correction light metering information and first brightness information;
S5: Determining a first exposure parameter set based on the first brightness value;
S6: Performing image exposure on the view-finding region of the second image based on the first exposure parameter set to obtain the second image;
S7: In response to a first imaging trigger operation, determining second transformation information based on the first horizon information and the preset horizon information corresponding to the preset light metering table;
S8: Determining a second correction light metering table based on the preset light metering table and the second transformation information;
S9: Determining a second brightness value corresponding to a view-finding region of a first image based on the second correction light metering information and second brightness information;
S10: Determining a second exposure parameter set based on the second brightness value; and
S11: Performing image exposure on the view-finding region of the first image based on the second exposure parameter set to obtain the first image, ensuring that brightness of the first region of the first image and the second region of the second image is substantially the same.

In this implementation, when the imaging apparatus recognizes the second imaging trigger operation, the first image is captured based on the second horizon information. When the imaging apparatus recognizes the first imaging trigger operation, the first image is captured based on the first horizon information, ensuring that the brightness of the first region of the first image and the second region of the second image is substantially the same, even when the imaging poses of the first and second images are different. This ensures exposure stability and consistency of the overlapping view-finding region in different images, enhancing user experience.

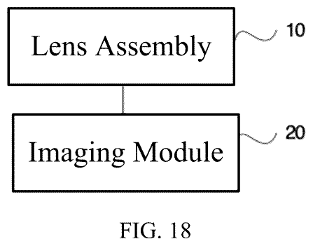

In an implementation, an imaging apparatus is provided. Referring to FIG. 18, the imaging apparatus includes a lens assembly 10 and an imaging module 20. The imaging module 20 is configured to capture a first image based on first orientation information in response to a first imaging trigger operation, ensuring that the brightness of the first region of the first image and the second region of the second image is substantially the same. The imaging poses of the first and second images are different, and the overlapping view-finding region includes the first and second regions.

In this implementation, when the imaging apparatus recognizes the first imaging trigger operation, the imaging module 20 captures the first image based on the first orientation information, ensuring that the brightness of the first region of the first image and the second region of the second image is substantially the same, even when the imaging poses of the first and second images are different. This ensures exposure stability and consistency of the overlapping view-finding region in different images, enhancing user experience.

In one implementation, the first orientation information includes any one or any combination of first camera pose information, first horizon information, first gravity direction information, or first forward direction information.

In one implementation, the method of obtaining the first horizon information includes: obtaining the first horizon information through artificial intelligence recognition; or determining the first horizon information based on first camera pose information; or determining the first horizon information based on gyroscope data of the imaging apparatus.

In one implementation, the imaging pose of the first image and the imaging pose of the second image are different poses of the imaging apparatus in the same imaging scene.

In one implementation, under the imaging pose of the first image and the imaging pose of the second image, the direction of the lens of the imaging apparatus is different.

In one implementation, under the imaging pose of the first image and the imaging pose of the second image, the optical axes of the lens of the imaging apparatus are substantially parallel or form an included angle.

In one implementation, if the optical axis of the lens of the imaging apparatus forms an included angle under the imaging pose of the first image and the imaging pose of the second image, the optical axis of the lens is inclined in different directions relative to the horizontal plane.

In one implementation, under the imaging pose of the first image, the optical axis of the lens of the imaging apparatus forms an included angle with the gravity direction; and/or under the imaging pose of the second image, the optical axis of the lens of the imaging apparatus is substantially perpendicular to the gravity direction.

In one implementation, the view-finding region of the second image corresponds to a default light metering table. The imaging module 20 is further configured to: determine a first pose change amount from the imaging pose of the second image to the imaging pose of the first image based on the first orientation information; move or transform the default light metering table based on the first pose change amount to obtain an updated light metering table; and capture the first image based on the updated light metering table.

In one implementation, before capturing the first image based on the first orientation information in response to the first imaging trigger operation, the imaging module 20 is further configured to: capture the second image based on the second orientation information in response to a second imaging trigger operation.

In one implementation, the imaging module 20 is further configured to: adjust current exposure parameters of the imaging apparatus based on the second orientation information to obtain the second image in response to the second imaging trigger operation; adjust current exposure parameters of the imaging apparatus based on the first orientation information to obtain the first image in response to the first imaging trigger operation, where the brightness of the first region and the brightness of the second region both correspond to the brightness of a current imaging scene.

In one implementation, the second orientation information includes any one or any combination of second camera pose information, second horizon information, second gravity direction information, or second forward direction information.

In one implementation, the method of obtaining the second horizon information includes: obtaining the second horizon information through artificial intelligence recognition; or determining the second horizon information based on second camera pose information; or determining the second horizon information based on gyroscope data of the imaging apparatus.

In one implementation, the imaging module 20 is further configured to: determine first correction light metering information based on the second orientation information and preset light metering information; perform image exposure based on the first correction light metering information to obtain the second image; determine second correction light metering information based on the first orientation information and preset light metering information; and perform image exposure based on the second correction light metering information to obtain the first image.

In one implementation, the preset light metering information includes a preset light metering table, which is configured to characterize preset light metering weights corresponding to a plurality of light metering sub-regions into which a light metering region of the imaging apparatus is divided. The first correction light metering information includes a first light metering table, which is configured to characterize first light metering weights corresponding to the plurality of light metering sub-regions. The second correction light metering information includes a second light metering table, which is configured to characterize second light metering weights corresponding to the plurality of light metering sub-regions.

In one implementation, the preset light metering weight corresponding to a light metering sub-region at the center of the light metering region is greater than the preset light metering weight of a light metering sub-region at the edge of the light metering region.

In one implementation, the imaging module 20 is further configured to: determine first transformation information based on the preset light metering information corresponding to the second orientation information and the preset pose information. The first transformation information is used to characterize the degree and/or mode of pose change from the preset pose to the imaging pose of the second image; determine first correction light metering information based on the preset light metering information and the first transformation information; determine second transformation information based on the first orientation information and the preset pose information corresponding to the preset light metering information, where the second transformation information is used to characterize the degree and/or mode of pose change from the preset pose to the imaging pose of the first image; and determine second correction light metering information based on the preset light metering information and the second transformation information.

In one implementation, under the preset pose, the optical axis of the lens of the imaging apparatus is in a horizontal direction.

In one implementation, the imaging module 20 is further configured to: determine first correction light metering information based on the first transformation information and preset configuration information corresponding to the preset light metering information. The preset configuration information is used to characterize the correspondence between the degree and/or mode of pose change and the light metering information after the pose change; and determine second correction light metering information based on the second transformation information and preset configuration information corresponding to the preset light metering information.

In one implementation, the first transformation information includes a pose change amount of the imaging apparatus along a first preset direction. The imaging module 20 is further configured to: if the pose change amount of the imaging apparatus along the first preset direction is within a first preset range, translate and replace the preset light metering weights of the plurality of light metering sub-regions along a reverse direction of the first preset direction to obtain the first correction light metering information.

In one implementation, the second transformation information includes a pose change amount of the imaging apparatus along a second preset direction. The imaging module 20 is further configured to: if the pose change amount of the imaging apparatus along the second preset direction is within a second preset range, translate and replace the preset light metering weights of the plurality of light metering sub-regions along a reverse direction of the second preset direction to obtain the second correction light metering information.

In one implementation, the imaging module 20 is further configured to: determine a first brightness value corresponding to the view-finding region of the second image based on the first correction light metering information and first brightness information. The first brightness information is used to characterize brightness data corresponding to a plurality of light metering sub-regions into which a light metering region of the second image is divided under the imaging pose of the second image; determine a first exposure parameter set based on the first brightness value. The first exposure parameter set includes a plurality of first exposure parameters configured for image exposure; perform image exposure on the view-finding region of the second image based on the first exposure parameter set to obtain the second image; determine a second brightness value corresponding to the view-finding region of the first image based on the second correction light metering information and second brightness information. The second brightness information is used to characterize brightness data corresponding to a plurality of light metering sub-regions into which a light metering region of the first image is divided under the imaging pose of the first image; determine a second exposure parameter set based on the second brightness value, where the second exposure parameter set includes a plurality of second exposure parameters configured for image exposure; and perform image exposure on the view-finding region of the first image based on the second exposure parameter set to obtain the first image.

In some implementations, the imaging apparatus further includes a determining module, which is configured to: determine the preset light metering information based on a preset custom operation of a user; or determine one of a plurality of pieces of initial light metering information as the preset light metering information based on a preset selection operation of a user.

Those skilled in the art will readily understand other implementations of the present disclosure upon consideration of the specification and practice of the present disclosure disclosed herein. The present disclosure intends to cover any modifications, uses, or adaptations of the present disclosure that follow the general principles of the present disclosure and include common knowledge or conventional technical means in the technical field not disclosed in this publication. The specification and examples are to be considered as exemplary only, and the true scope and spirit of the present disclosure is indicated by the following claims.

It should be understood that the present disclosure is not limited to the precise structure already described and shown in the drawings, and various modifications and changes can be made without departing from its scope. The scope of the present disclosure is limited only by the appended claims.

What is claimed is:

1. An imaging method, applied to an imaging apparatus, wherein the imaging method comprises:
in response to a first imaging trigger operation, capturing a first image based on first orientation information, a brightness difference between a first region of the first image and a second region of a second image being less than a preset brightness difference,
wherein the first image and the second image are captured in different imaging poses, and an overlapping view-finding region comprises the first region and the second region.

2. The imaging method according to claim 1, wherein the first orientation information comprises at least one information type of a plurality of types of first camera pose information, first horizon information, first gravity direction information, or first forward direction information.

3. The imaging method according to claim 2, wherein the first horizon information is obtained by one of:
obtaining the first horizon information through artificial intelligence recognition; or
determining the first horizon information based on the first camera pose information; or
determining the first horizon information based on gyroscope data of the imaging apparatus.

4. The imaging method according to claim 1, wherein an imaging pose of the first image and an imaging pose of the second image are different poses of the imaging apparatus in a same imaging scene.

5. The imaging method according to claim 1, wherein under an imaging pose of the first image and an imaging pose of the second image, a direction of a lens of the imaging apparatus is different.

6. The imaging method according to claim 1, wherein under an imaging pose of the first image and an imaging pose of the second image, optical axes of a lens of the imaging apparatus are substantially parallel or form an included angle.

7. The imaging method according to claim 6, wherein under an imaging pose of the first image and an imaging pose of the second image, when optical axes of a lens of the imaging apparatus form an included angle, the optical axes of the lens of the imaging apparatus are inclined in different directions relative to a horizontal plane.

8. The imaging method according to claim 1, wherein at least one of the following is satisfied:
under an imaging pose of the first image, an optical axis of a lens of the imaging apparatus forms an included angle with a gravity direction; or
under an imaging pose of the second image, an optical axis of a lens of the imaging apparatus is substantially perpendicular to the gravity direction.

9. The imaging method according to claim 8, wherein the second image has a default light metering table corresponding to the view-finding region; and
wherein capturing the first image based on the first orientation information comprises:
determining a first pose change amount from the imaging pose of the second image to the imaging pose of the first image based on the first orientation information;
moving or transforming the default light metering table to obtain an updated light metering table based on the first pose change amount; and
capturing the first image based on the updated light metering table.

10. The imaging method according to claim 1, wherein before capturing the first image based on the first orientation information in response to the first imaging trigger operation, the method further comprises:
capturing the second image based on second orientation information in response to a second imaging trigger operation.

11. The imaging method according to claim 10, wherein:
capturing the second image based on the second orientation information in response to the second imaging trigger operation comprises:
in response to the second imaging trigger operation, adjusting current exposure parameters of the imaging apparatus based on the second orientation information to obtain the second image; and
capturing the first image based on the first orientation information in response to the first imaging trigger operation comprises:
in response to the first imaging trigger operation, adjusting current exposure parameters of the imaging apparatus based on the first orientation information to obtain the first image, and wherein a brightness of the first region and a brightness of the second region both correspond to a brightness of a current imaging scene.

12. The imaging method according to claim 10, wherein the second orientation information comprises at least one information type of a plurality of types of second camera pose information, second horizon information, second gravity direction information, or second forward direction information.

13. The imaging method according to claim 12, wherein the second horizon information is obtained by one of the following:
obtaining the second horizon information through artificial intelligence recognition; or
determining the second horizon information based on the second camera pose information; or
determining the second horizon information based on gyroscope data of the imaging apparatus.

14. The imaging method according to claim 10, wherein:
capturing the second image based on the second orientation information in response to the second imaging trigger operation comprises:
determining first correction light metering information based on the second orientation information and preset light metering information; and
performing image exposure based on the first correction light metering information to obtain the second image; and
capturing the first image based on the first orientation information in response to the first imaging trigger operation comprises:
determining second correction light metering information based on the first orientation information and the preset light metering information; and
performing image exposure based on the second correction light metering information to obtain the first image.

15. The imaging method according to claim 14, wherein:
the preset light metering information comprises a preset light metering table, and the preset light metering table is configured to characterize preset light metering weights corresponding to a plurality of light metering sub-regions into which a light metering region of the imaging apparatus is divided;
the first correction light metering information comprises a first light metering table, and the first light metering table is configured to characterize first light metering weights corresponding to the plurality of light metering sub-regions; and
the second correction light metering information comprises a second light metering table, and the second light metering table is configured to characterize second light metering weights corresponding to the plurality of light metering sub-regions.

16. The imaging method according to claim 15, wherein preset light metering weight corresponding to a light metering sub-region at a center of the light metering region is greater than preset light metering weight of a light metering sub-region at an edge of the light metering region.

17. The imaging method according to claim 15, wherein:
determining the first correction light metering information based on the second orientation information and the preset light metering information comprises:
determining first transformation information based on the second orientation information and preset pose information corresponding to the preset light metering information, and wherein the first transformation information is configured to characterize at least one of a pose change degree or a pose change mode from a preset pose to an imaging pose of the second image; and
determining the first correction light metering information based on the preset light metering information and the first transformation information; and
determining the second correction light metering information based on the first orientation information and the preset light metering information comprises:
determining second transformation information based on the first orientation information and preset pose information corresponding to the preset light metering information, and wherein the second transformation information is configured to characterize at least one of a pose change degree or a pose change mode from the preset pose to an imaging pose of the first image; and
determining the second correction light metering information based on the preset light metering information and the second transformation information.

18. The imaging method according to claim 14, wherein:
performing image exposure based on the first correction light metering information to obtain the second image comprises:
determining a first brightness value corresponding to the view-finding region of the second image based on the first correction light metering information and first brightness information, wherein the first brightness information is configured to characterize brightness data corresponding to a plurality of light metering sub-regions into which a light metering region of the second image is divided under an imaging pose of the second image;
determining a first exposure parameter set based on the first brightness value, wherein the first exposure parameter set comprises a plurality of first exposure parameters configured for image exposure; and
performing image exposure on the view-finding region of the second image based on the first exposure parameter set to obtain the second image; and
performing image exposure based on the second correction light metering information to obtain the first image comprises:
determining a second brightness value corresponding to the view-finding region of the first image based on the second correction light metering information and second brightness information, wherein the second brightness information is configured to characterize brightness data corresponding to a plurality of light metering sub-regions into which a light metering region of the first image is divided under an imaging pose of the first image;
determining a second exposure parameter set based on the second brightness value, wherein the second exposure parameter set comprises a plurality of second exposure parameters configured for image exposure; and
performing image exposure on the view-finding region of the first image based on the second exposure parameter set to obtain the first image.

19. The imaging method according to claim 14, further comprising:
determining the preset light metering information based on a preset custom operation of a user; or
determining one of a plurality of pieces of initial light metering information as the preset light metering information based on a preset selection operation of a user.

20. An imaging apparatus, comprising:
a lens assembly; and
a imaging module, wherein the imaging module is configured to, in response to a first imaging trigger operation, capture a first image based on first orientation information, a brightness difference between a first region of the first image and a second region of a second image being less than a preset brightness difference,
wherein the first image and the second image are captured in different imaging poses, and an overlapping view-finding region comprises the first region and the second region.
